(19) United States
(12) Patent Application Publication
(10) Pub. No.: US 2007/0030405 A1
(43) Pub. Date: Feb. 8, 2007

(54) Remotely controlled wall-mounted television bracket

(76) Inventors: Joseph B. Childrey, La Jolla, CA (US); Robert Raos, Milpitas, CA (US)

Correspondence Address: GREENBERG TRAURIG, 3773 HOWARD HUGHES PARKWAY, SUITE 500 NORTH, LAS VEGAS, NV, 89169, US

(21) Appl. No.: 11/231,117

(22) Filed: Sep. 19, 2005

Related U.S. Application Data
(63) Continuation-in-part of application No. 10/722,942, filed on Nov. 25, 2003.

(51) Int. Cl. H04N 5/64

(52) U.S. Cl. 348/794

(57) ABSTRACT

A flat panel television mounting system is disclosed. The system includes an arm connected to a wall structure at a first end and to a flat panel television bracket at a second end. In one version, the arm may include two independent sections. One or more motors control the movements of the arm sections to move the flat panel television away from, or towards, a wall structure. Motors also control tilt and swivel functions. All flat panel television movements are controlled by a remote control device.

### CROSS-REFERENCE TO RELATED APPLICATIONS

This application is a continuation-in-part of application Ser. No. 10/722,942 filed Nov. 25, 2003.

### FIELD OF INVENTION

The embodiments of the present invention relate to a controllable wall-mounted support. More particularly, a remotely controlled wall-mounted bracket for a flat panel television or similar article is disclosed.

### BACKGROUND

As technology continues its exponential advancement, consumers reap the rewards. One particular example relates to the availability of new types of televisions, namely flat panel televisions. Some of the most popular types of flat panel televisions are facilitated by plasma, LCD or organic light-emitting diode technology. Such technology allows flat panel televisions to be built only inches thick.

While flat panel televisions are relatively expensive, it is anticipated that prices will fall and sales will double each year for at least the next couple of years. In fact, while only 2% of current television sales comprise flat panel models, it is predicted that the percentage will increase to 10% by 2006. The predictions are supported by the constant news regarding new companies entering the flat panel television market. In just the last year, Gateway7, Dell7 and Hewlett-Packard7 have announced they will enter the flat panel television market.

While the flat panel technology is excellent and improving seemingly every day, there is still a continuing problem with flat panel televisions which hang on a wall or other flat support surface. That is, the ability to view the television from an optimum vantage point is limited. Since flat panel televisions are fixedly mounted flush with a wall or other support surface, they dictate the arrangement of furniture and other items in the subject room. In the past, conventional cathode ray tube televisions have been supported by movable stands or rested on rotatable surfaces which make the televisions mobile thereby eliminating much of the concern over the ability to view the television from an optimum angle (i.e., straight on).

Thus, there continues to be the need for a device, mechanism or method of controlling the orientation of a mounted flat panel television. Moreover, it is desired that the device, mechanism or method be specifically designed for newly manufactured flat panel televisions and also available as an after market product. Importantly, the operation of the device, mechanism or method of controlling the orientation should be capable of being remotely controlled.

### SUMMARY

Accordingly, the embodiments of the present invention comprise a wall-mounted bracket for supporting a flat panel television or similar mounted article. The bracket is further remotely controlled so that the orientation of the flat panel television may be articulated or adjusted, including tilt, swivel, up, down, right, left, in, out and any combination thereof, to suit any viewing arrangement.

In a first embodiment, four threaded rods form a rectangular support bracket. Four attachment members positioned at each corner of the support bracket, and connecting the four threaded rods, provide a means for securing the bracket to a wall or similar support surface. Two motorized carriages, which traverse along each rod, in conjunction with corresponding rigid tubes joined to the television provide a means for adjusting the orientation of the television display or screen.

By causing the carriages to traverse along the threaded rods, the attached rigid tubes alter the position of the television accordingly. For example, by moving the carriages on a right vertical threaded rod to a generally upper position and the carriages on a left vertical threaded rod to a generally lower position, the television display is turned in a counter-clockwise fashion. Similarly, to move the television display in a right or left direction, the carriages on both the upper and lower horizontal threaded rods are moved in the respective direction. The precise movement of the carriages related to various television orientations is explained in more detail below.

Movement of the carriages is controlled by a remote control device similar to the remote control device used with a television. In fact, the remote operation of the carriages is suitable for integration into a conventional television remote control device or may be subject to its own separate remote control device. The operation of the separate remote control device can also be downloaded into a universal remote control device thereby reducing the number of remote control devices needed to operate an complete entertainment system of electronic devices. The remote control device may be facilitated by infrared, FM or any other suitable signals. Receivers incorporated within the carriages receive the signals transmitted by the remote control device and processors or similar devices cause the carriages to traverse accordingly.

The embodiments of the present invention permit a user to position the flat panel display in the optimum viewing position regardless of the user's position within a viewing room. Moreover, many homes include rooms separated by a short wall, railing or likewise. In such circumstances, the television display may be positioned so that a user can view the display optimally from one or more adjoining rooms. For example, even while cooking dinner in a kitchen adjoining the room being occupied by the television, an individual can still watch the television from an optimum angle.

Alternative embodiments, modifications and variations are evident from the corresponding drawings, detailed description and claims as set forth herein.

### BRIEF DESCRIPTION OF THE DRAWINGS

FIG. 1 illustrates a front view of a first embodiment of the assembly with a flat panel television in a traditional position flush with a wall;

FIG. 2 illustrates a block diagram of a carriage incorporating a processor, signal receiver and motor;

FIG. 3 illustrates a front view of the first embodiment of the assembly with the flat panel television swivelled counter-clockwise;

FIG. 4 illustrates perspective front view of the first embodiment of the assembly with the flat panel television in a lowered position;

FIG. 5 illustrates a perspective front view of the first embodiment of the assembly with the television shifted to the right;

FIG. 6 illustrates a top view of the first embodiment of the assembly with the television shifted to the right;

FIG. 7 illustrates a perspective front view of the first embodiment of the assembly with the left portion of the television titled outward from the wall;

FIG. 8 illustrates a top view of the first embodiment of the assembly with a portion of the television tilted outward from the wall;

FIG. 9 illustrates a side view of the first embodiment of the assembly with a bottom portion of the television tilted outward from the wall;

FIG. 10 illustrates a detailed perspective view of a linear actuator of the first embodiment of the assembly;

FIG. 11 illustrates a side view of the assembly incorporating extensions for providing additional ranges of assembly motion;

FIG. 12 illustrates a first alternative embodiment;

FIG. 13 illustrates a second alternative embodiment;

FIG. 14 illustrates a remote control device;

FIG. 15 shows a perspective view of a fully-extended third alternative embodiment;

FIG. 16 shows a side view of a fully-extended third alternative embodiment;

FIG. 17 shows a top view of a fully-extended third alternative embodiment;

FIG. 18 shows a side view of a third alternative embodiment in a home position;

FIG. 19 shows a top view of a third alternative embodiment with the FPT angled;

FIG. 20 shows a top view of a third alternative embodiment with arm sections at a 90° angle to one another;

FIG. 21 shows a side view of a fully-extended wall-mounted third alternative embodiment;

FIG. 22 shows a top view of a fully-extended wall-mounted third alternative embodiment;

FIG. 23 shows a top view of a partially-extended wall-mounted third alternative embodiment;

FIG. 24 shows a top view of a wall-mounted third alternative embodiment in a home position; and

FIG. 25 shows a side view of a wall-mounted third alternative embodiment in a home position.

### DETAILED DESCRIPTION

Reference is now made to the figures wherein like parts are referred to by like numerals throughout. FIG. 1 illustrates a front view of a first embodiment of the bracket assembly, generally designated by reference numeral 100, with a flat panel television (AFPT@) 110 in a traditional position with its monitor, screen or display 115 flush and parallel with a support wall 117. The FPT 110 is shown joined to a plurality of movable carriages 120 by means of rigid tubes 130. In turn, the movable carriages 120 are attached to threaded rods 140 which, along with corner attachment members 145, form a bracket frame 105. The attachment members 145 include apertures 148 for receipt of nails, screws or similar wall fasteners.

The movement of the carriages 120 is facilitated by an internal motor (not shown). In a first embodiment, the carriages 120 may be electronic linear actuators. Activation of the internal motors causes the carriages 120 to traverse along the rods 140. Forward and rear motor directions allow the carriages 120 to move up, down, left and right along rods 140. As detailed below, the movement of the carriages 120 can be remotely controlled. The orientation of the FPT 110 is controlled by the combination of the movement of the carriages 120 and their impact on corresponding tubes 130 which join the carriages 120 to the FPT 110. The tubes 130 are generally rigid enough to both support and influence movement of the FPT 110. For ease of manufacture, the tubes 130 are pre-formed to prevent them from interfering with one another and to provide the necessary force on the FPT 110 to orientate the FPT 110 as desired. In addition, the tubes 130 are rotatably joined to the carriages 120 such that the rotation of the carriages 120 does not affect the position or orientation of the tubes 130.

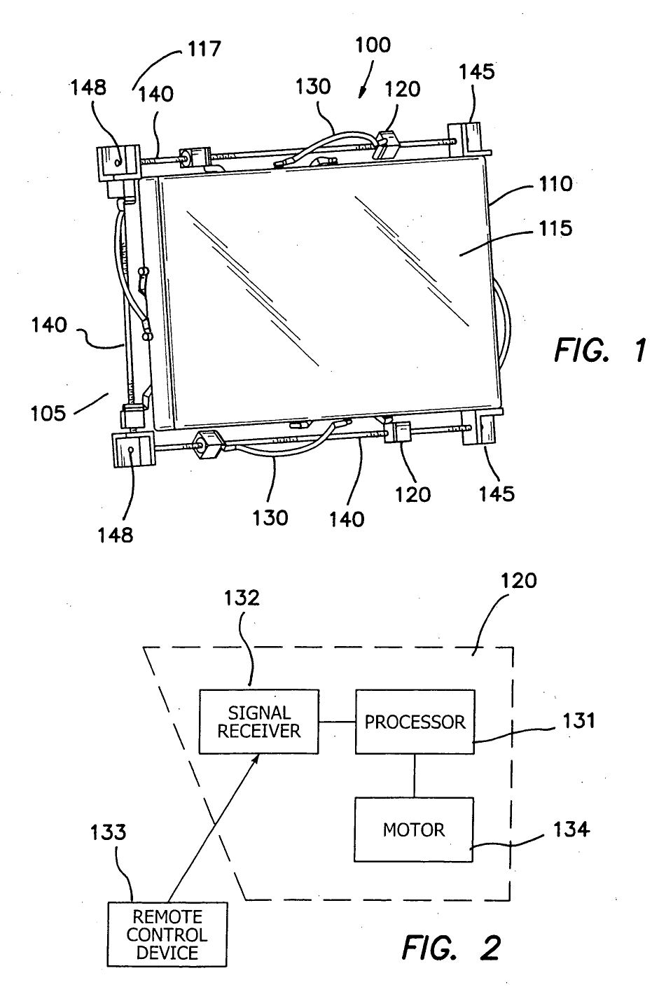

A block diagram of FIG. 2, shows an embodiment having a processor 131 integrated within a carriage 120 and in communication with signal receiver 132. The signal receiver 132 receives control signals transmitted from a wired or wireless remote control device 133. The control signals are then processed and/or interpreted by the processor 131 which instructs the carriage 120 to move accordingly. The processor 131 may be in electrical or wireless communication with the carriage 120 and its motors 134. As those skilled in the art understand software is necessary to drive the processor 131 which causes the desired carriage 120 movement to occur, the intimate software details are not set forth herein.

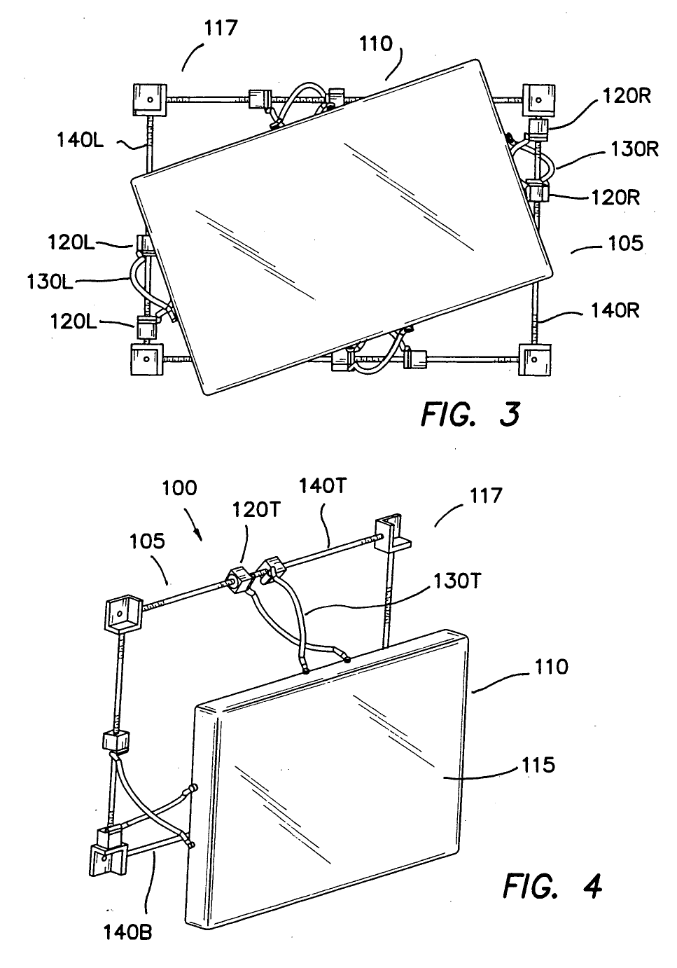

Now referring to FIG. 3, the FPT 110 has been orientated in a counter-clockwise position. To move into the counter-clockwise position as shown, the carriages 120R have moved upward along their supporting rod 140R while the carriages 120L have moved downward along their supporting rod 140L. In this manner, the tubes 130R and 130L act upon the FPT 110 causing the FPT 110 to move to the counter-clockwise position as shown.

FIG. 4 illustrates the FPT 110 in an orientation extended away from the frame 105 and supporting wall 117. Also, the FPT 110 has been lowered from the original orientation as shown in FIG. 1. To extend the FPT 110 to the position shown the carriages 120T have moved together near a center position of their supporting top rod 140T while the carriages (not visible) along bottom rod 140B have moved together near a center position of their supporting rod 140B. In this manner, the tubes 130T and the tubes (not visible) along the bottom rod 140B have extended away from the frame 105 thereby forcing the FPT 110 away from the frame 105.

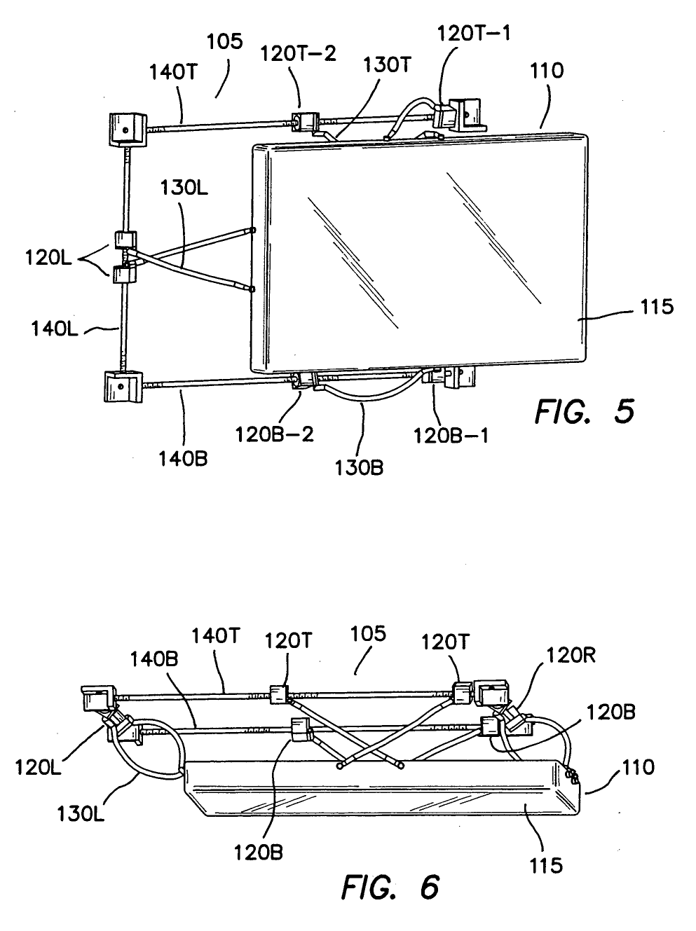

FIG. 5 illustrates the FPT 110 in an orientation shifted to the right of the original FPT 110 position as shown in FIG. 1. In this new orientation, the carriages 120L and carriages (not visible) along rod 140R are positioned near a center position of the rods 140L and 140R, respectively. One of the top carriages 120T-1 and bottom carriages 120B-1 have reached their horizontal limits. However, continued rightward motion by the second top carriage 120T-2 and second bottom carriage 120B-2 allow the FPT 110 to be shifted even farther in the rightward direction. Nonetheless, the length of each of the tubes 130L, 130R, 130T and 130B dictates the maximum distance the FPT 110 may be shifted in any direction. FIG. 6 shows an upper view of the FPT 110 as it is oriented in FIG. 5.

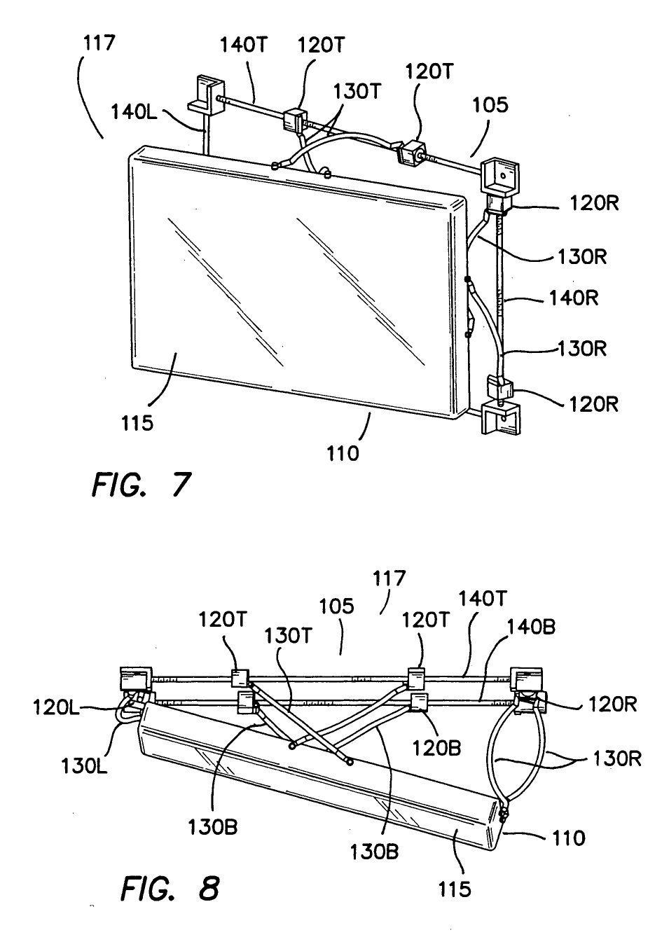

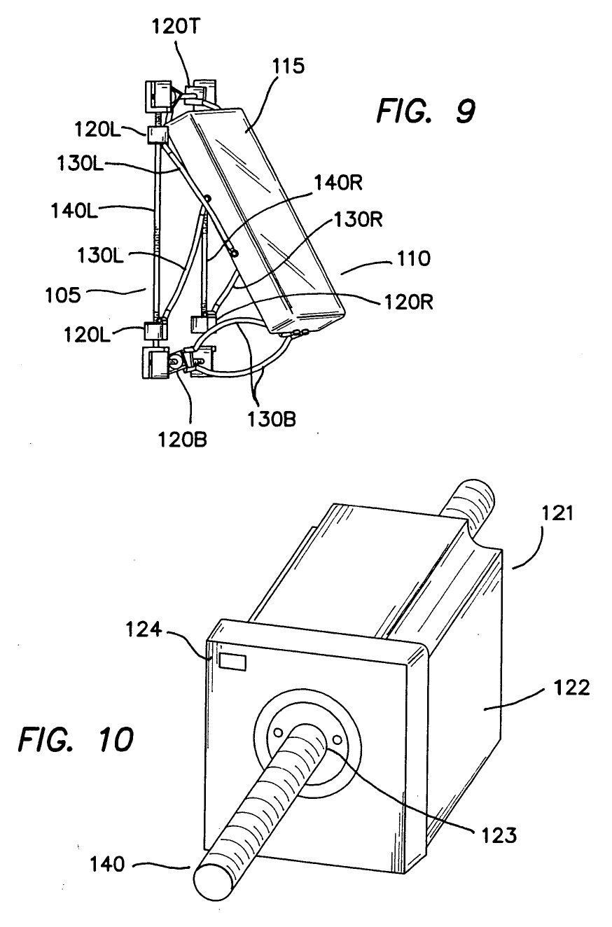

FIG. 7 illustrates the FPT 110 having a left portion extended from the frame 105 and support wall 117. In this manner, the left portion of the FPT 110 is angled outward for clearer viewing of the FPT display 115 by viewers seated to the right of the FPT 110. Similarly, FIG. 8 illustrates a top view of the FPT 110 having a right portion extended from the frame 105 and support wall 117. This orientation provides viewers seated to the left of the FPT 110 with an optimum view of the FPT display 115. Now referring to FIG. 9, a lower portion of the FPT 110 is extended from the frame 105 and support wall 117.

FIG. 10 illustrates a detailed perspective view of a carriage in the form of a linear actuator 121. The actuator 121 comprises a housing 122 for a motor (not shown). Opening 123 extends through the housing 122 so that the actuator 121 may traverse along a rod 140 about the opening 123. A window 124 or small opening integrated within said housing 122 allows an internal signal receiver access to a remotely transmitted control signal. An internal processor then instructs the actuator 121 to move along the rod 140 accordingly. The detailed operation of linear actuators and the like are known to those skilled in the art.

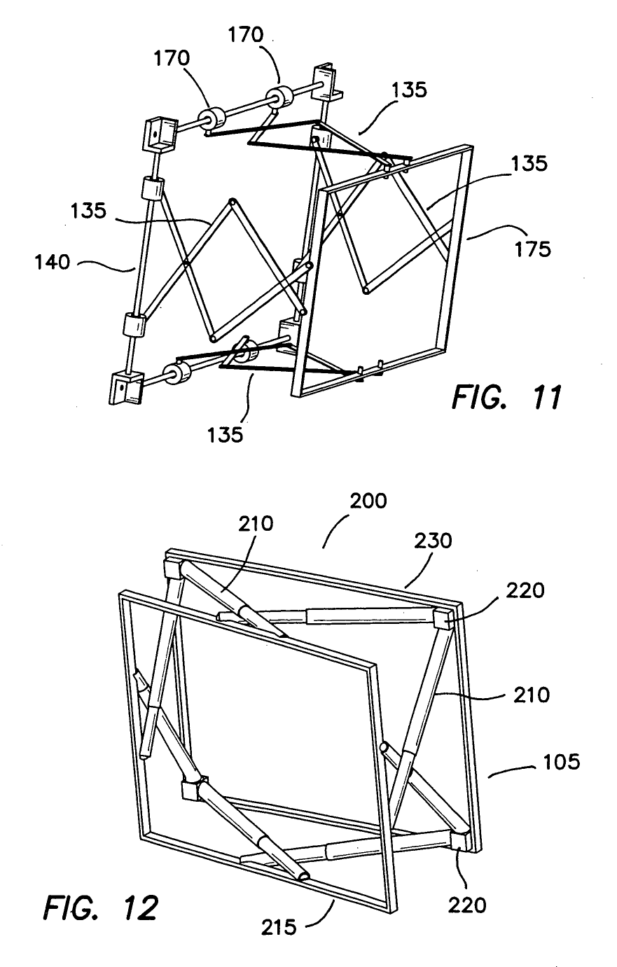

FIG. 11 shows a first alternative embodiment integrating extensions 135 between translatable rollers 170 and frame 175. Alternatively, the extensions may be joined directly to the FPT 110. The extensions 135 shown are of the scissor type but other types may serve the same purpose. First ends of the extensions 135 are rotatably joined to the rollers 170 and second ends are rotatably joined to the frame 175 or FPT 110. In this manner, the frame 175 or FPT 110 is free to move in any direction desired. In practice, as sets of rollers 170 are translated along rods 140 the extensions 135 either extend or retract causing the frame 175 or FPT 110 to orient as desired. The rollers 170 act identically to the carriages 120 and in fact may be replaced by the carriages 120. One or more processors control the movements of the rollers 170.

FIG. 12 illustrates a second alternative embodiment using a series of telescoping or piston members 210. A first end of each telescoping member 210 is rotatably joined to rigid blocks 220 positioned at each corner of frame member 230. In this manner, the telescoping members 210 are free to move in any number of directions. As with the tube and carriage embodiment described above, the telescoping members 210 are remotely controlled by means of a remote control device and one or more processors integrated within the assembly 200 or the telescoping members 210. The one or more processors act in response to signals received from the remote control device to orientate the FPT 110 in the desired position. As set forth above, the signal receivers may also be incorporated in the processor or may be separate devices in communication with said processors. Frame 215 may be used to support the FPT 110 or the telescoping members 210 may be attached directly to the FPT 110.

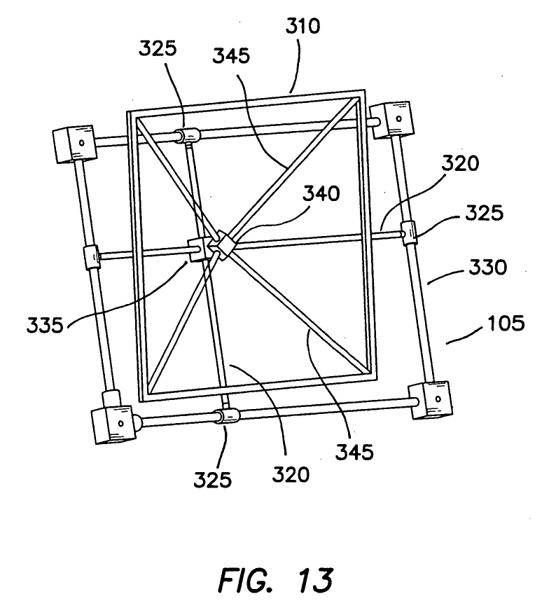

FIG. 13 illustrates a third alternative embodiment comprising a motor-driven frame member 310 supported by a pair of perpendicular rods 320. The perpendicular rods 320 provide means for the FPT 110 to be moved up, down, left and right. The rods 320 are joined to an outer frame assembly 330 by sleeves 325 such that the rods 320 are able to traverse therealong in either vertical or horizontal directions. Additional directions of movement are achieved by means of a rotatable joint member 340 integrated between the frame member 310 and the rods 320. Rods 345 extending from the joint member 340 provide means for the frame member 310 to be positioned. The rotatable joint member 340 allows tilt, swivel and rotation of the FPT 110. A processor integrated within the assembly 300 or the rotatable joint member 340 controls the operation of the rods 320 and rotatable joint member 340 in response to received control signals. Again, the frame 310 may be used to support the FPT 110 or may be attached directly to the FPT 110

It should be evident to those skilled in the art that the FPT 110 and its display 115 may be oriented in an infinite number of positions and is only limited by the mobility of the implemented positional devices (e.g., liner actuators, mobile frame, ball screw actuators, etc.).

Many other features and options are possible with each of the embodiments disclosed above. For instance, a leveler may be incorporated on the assembly to ensure that, if desired, the FPT 110 and its display 115 are level along a horizontal reference line at any orientation. Such leveling will occur automatically and without the need for the user to use the remote control device in an attempt to level the assembly remotely. In addition, a home, conventional or default position may be preprogrammed such that the remote control device includes a button dedicated to returning the FPT 110 to its home position. Similarly, multiple preferred orientations may be preprogrammed such that individual remote control device buttons may facilitate the preferred orientations.

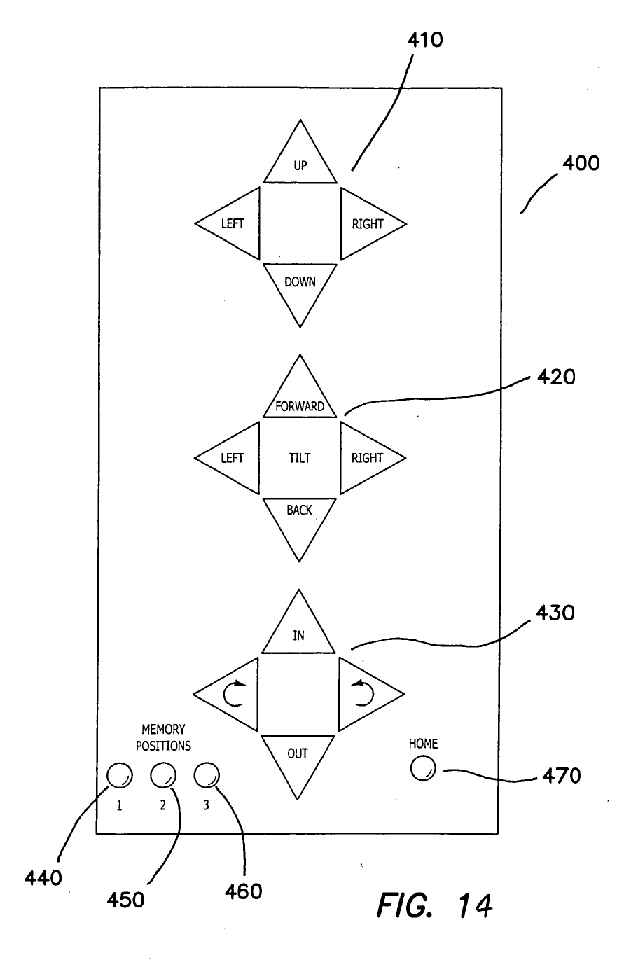

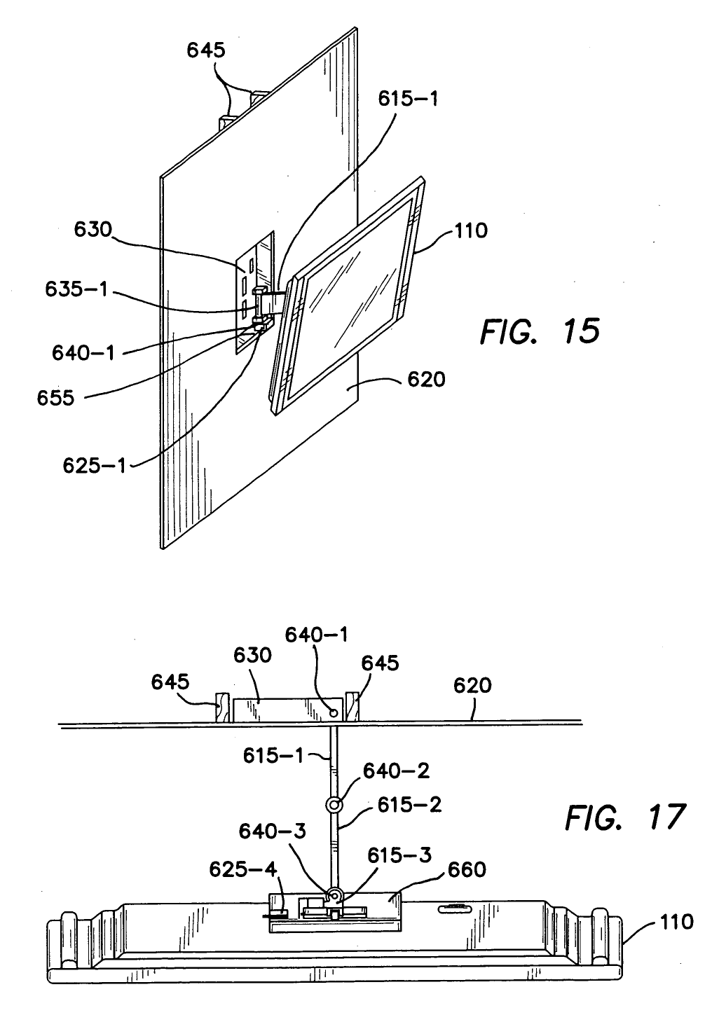

FIG. 14 shows a wireless remote control device 400 which may be used to operate the assemblies of the embodiments of the present invention. In the embodiment shown, a first group of buttons 410 controls the up, down, right and left assembly movements, a second group of buttons 420 controls the tilt assembly movements and a third group of buttons 430 controls the clockwise and counterclockwise assembly movements. A fourth group of buttons 440, 450 and 460 corresponds to preprogrammed assembly positions. Thus, each of the buttons 440, 450 and 460 may be used to orientate the assembly into preferred stored positions. Button 470 returns the FPT 110 to a home position. Should the remote control device 400 lose power (e.g., batteries die), ideally the assembly automatically locks into a preprogrammed or default position as desired by the user. The processor 131, or memory in communication with the processor 131, is responsible for storing the preset and home positions.

Ideally, power is supplied to the remotely controlled assembly by an electrical cord suitable for plugging-in to a conventional outlet or by battery means. With either power supply means, it is preferred that the means be concealed from view.

While the description has focused on a wireless remote control device, it is understood that the remote control device may be wired and/or affixed to the wall adjacent the FPT 110. In this manner, the processor receives the control signals via an electrical connection (e.g., wire). Also, the processors may be integrated into numerous assembly positions as long as they are in communication with the positional devices.

FIGS. 15-25 illustrate an alternative embodiment of the remotely-controlled wall bracket assembly 600. In this alternative embodiment, a single arm is responsible for extending the FPT 110 outwardly from the wall. As set forth below, the alternative embodiment may be mounted directly on the wall or in a recessed manner.

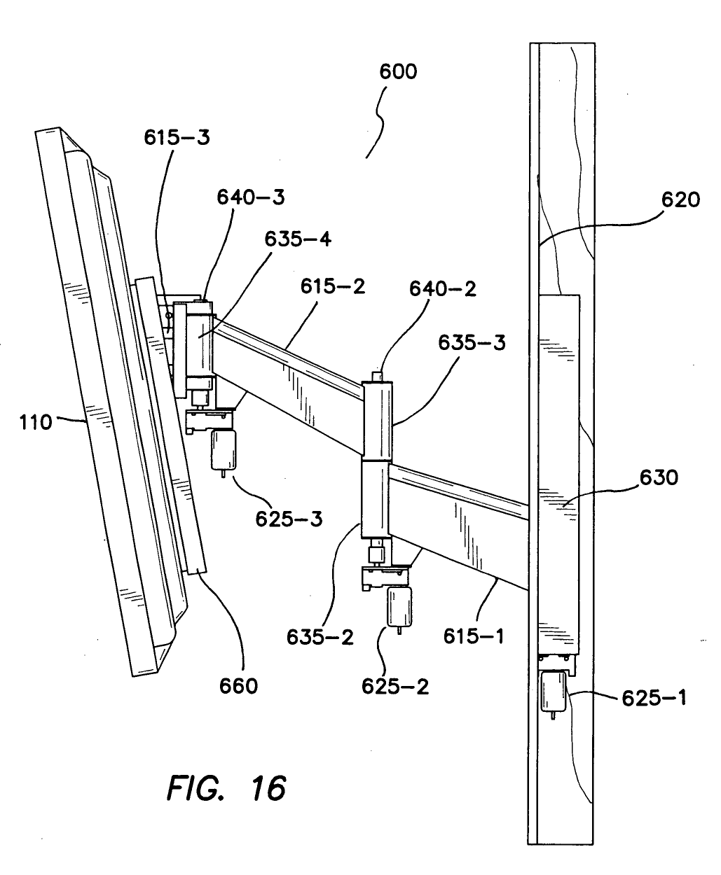

FIGS. 15 and 16 show a side view and top perspective view of the wall bracket assembly 600 with the FPT 110 in a fully extended position. In other words, a maximum distance between the wall 620 and the FPT 110 has been achieved. As shown, the wall bracket 600 is mounted such that a wall support 630 is recessed within the wall 620. A recessed mounting allows the FPT 110 to rest nearly flush against the wall 620 while in a home position. In one embodiment, the bracket assembly 600 permits the FPT 110 to rest in the home position with a 2.5″ space between the FPT 110 and the surface of the wall 620. As set forth below, a wall support 670 may also be mounted on the surface of the wall 620.

In this alternative embodiment, three arm sections 615-1 through 615-3 and up to four gear motors 625-1 through 625-4 provide means for positioning the FPT 110. Merkle-Korff Industries of Des Plaines, Ill. manufactures and distributes a suitable gear motor under its VFO series. A first end of the first arm section 615-1 is connected to the wall support 630 via first drive shaft 640-1 and a second end is connected to a second drive shaft 640-2. A first end of the second arm section 615-2 is connected to the second drive shaft 640-2 and a second end is connected to a third drive shaft 640-3 adjacent to a mounting bracket 660 that supports the FPT 110. The mounting bracket 660 may be connected to a rear surface of the FPT 110 in any number of ways including screws, pins and similar fastening devices. The mounting bracket 660 may be designed to accommodate different brands of FPTs. In one embodiment, the ends of the arm sections 615-1 and 615-2 include collars 635-1 through 635-4 with openings along their length to receive the drive shafts 640-1 through 640-3.

As shown, the wall support 630 is sized to fit into a cavity formed between two parallel wall studs 645 and fabricated of a rigid alloy, composite, plastic or similar material having similar properties. The wall support 630 is secured within the wall 620 to the two parallel wall studs 645. Typically, wall studs 645 are spaced 16″ or 24″ apart. Accordingly, the dimensions of the wall support 630 may be varied to accommodate the spacing of the subject wall studs 645. During installation, a vertical member (e.g., 2×4), which acts as a shelf for the support tray 630, may also be secured to the two wall studs 645. An upper and/or lower surface of the wall support 630 secures the first drive shaft 640-1 to which the first end of the first arm section 615-1 is connected.

A first gear motor 625-1 controls rotation of the first arm section 615-1 by rotating the attached first drive shaft 640-1. The first gear motor 625-1 is capable of manipulating the first arm section 615-1 through a pre-established range of motion. For example, the gear motor 625-1 may be capable of moving the first arm section 615-1 between a 0° home position (i.e., parallel to the wall 620) and a 90° fully extended position (i.e., perpendicular to the wall 620). A second gear motor 625-2 manipulates the second arm 615-2 through a similar range of motion by rotating the attached second drive shaft 640-2. It is conceivable that the range of motion may be broader. The second drive shaft 640-2 is free to rotate relative to collar 635-1 while collar 635-2 is connected to the second drive shaft 640-2. FIG. 17 shows a top view of the bracket 600 with both arm sections 615-1, 615-2 in aligned 90° positions relative to the wall 620.

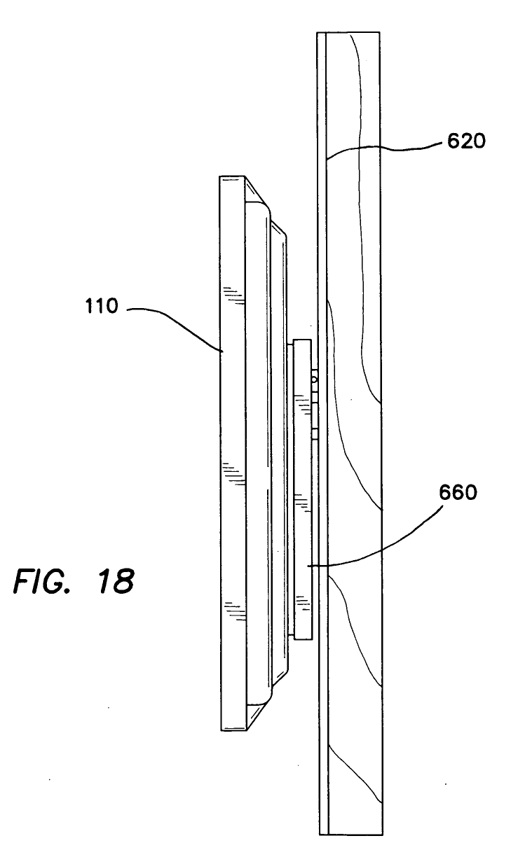

When in a home position, the arm sections 615-1, 615-2 are contained within the support tray 630. While the FPT 110 is in the home position, the first arm section 615-1 and second arm section 615-2 fold into the support tray 630 and rest in generally the same vertical plane. FIG. 18 shows a side view of the bracket 600 with the FPT 110 in the home position.

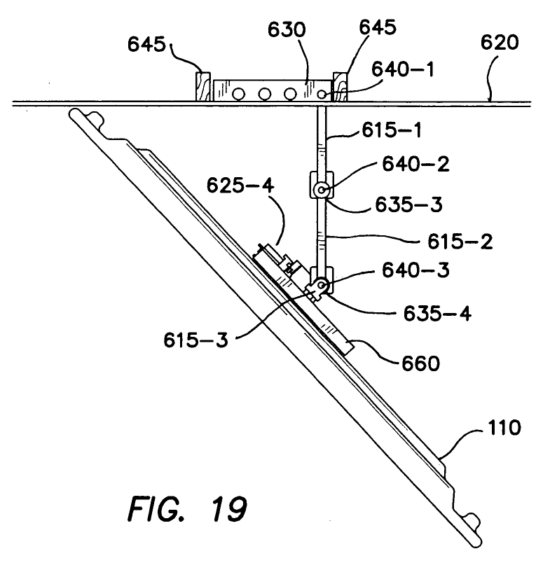

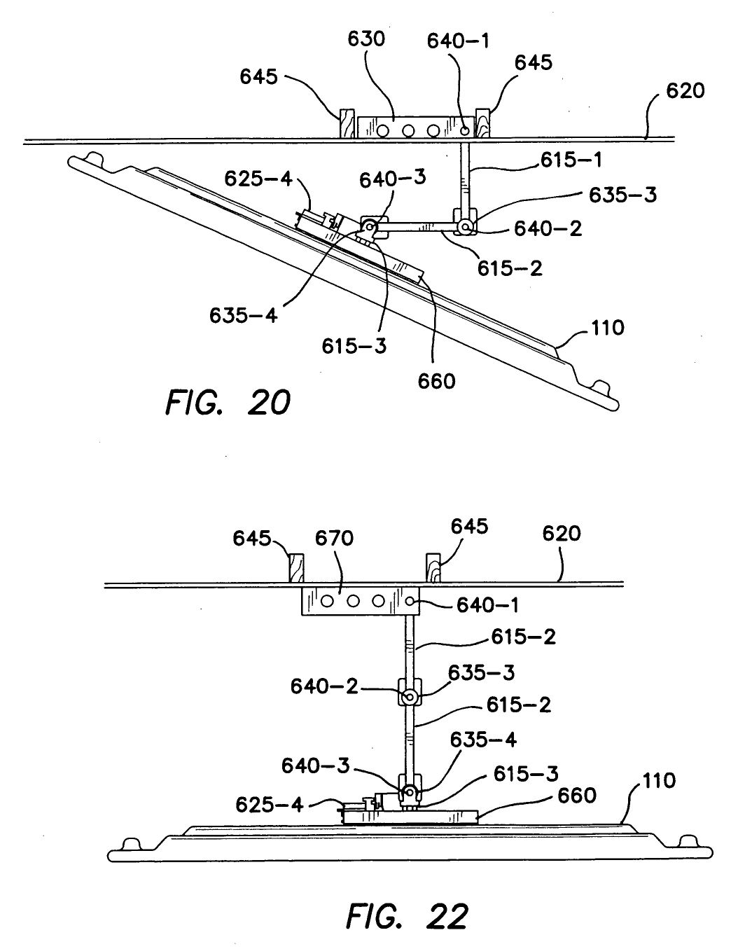

A third gear motor 625-3 manipulates the FPT 110 in a swivel pattern by rotating the third drive shaft 640-3 which is connected to a short third arm section 615-3 connected to the mounting bracket 660. FIG. 19 shows an upper view of the bracket 600 with the FPT 110 positioned at a 45° angle relative to the wall 620. Ideally, the FPT 110 is free to rotate significantly in either direction as desired by a user. The primary restrictions regarding the swivel range relate to the size of the FPT 110 and its distance from the wall 620. FIG. 20 shows an upper view with the second arm section 615-2 positioned at a 90° angle to the first arm section 615-1 such that the angle between the FPT 110 and the wall 620 is less than the angle shown in FIG. 19. The independent movement of the first arm section 615-1 and second arm section 615-2 provides a broad range of FPT 110 movements and final positions.

A fourth gear motor 625-4 manipulates the FPT 110 in a tilt pattern by rotating the mounting bracket 660 about a horizontal axis. FIGS. 15 and 16 show the FPT 110 tilted at a 10° angle with a vertical line. In most practical situations, the FPT 110 only needs to tilt downward but it can be fabricated to tilt upward as well. In fact, dependent on the user, the tilt feature is optional altogether.

The electronics and motors of the bracket assembly 600 are powered by a electrical outlet adapter plugged into a power outlet or a dedicated power source such as a battery.

As with the previous embodiments, a remote control device 400 and signal receiver (not shown) are used to position the FPT 110. Software embedded in a processor board facilitates remote positioning of the FPT 110 including control of the gear motors 625-1 through 625-4. The software may also facilitate other features of the bracket assembly 600. The other features include a home position setting, multiple user-defined memory pre-sets, controlled acceleration and deceleration, safety interlock system and manual override.

One such safety feature utilizes sensors to prevent the FPT 110 from swiveling into the wall 620 or pinning an item (e.g., child) between the FPT 110 and the wall 620. Importantly, the software associated with the bracket 600 tracks, maintains and/or records the real time position of the FPT 110 at all times. Such information allows the software to analyze sensor signals to automatically stop movement of the FPT 110 to prevent the FPT 110 from being unintentionally damaged by contacting a wall or other rigid object.

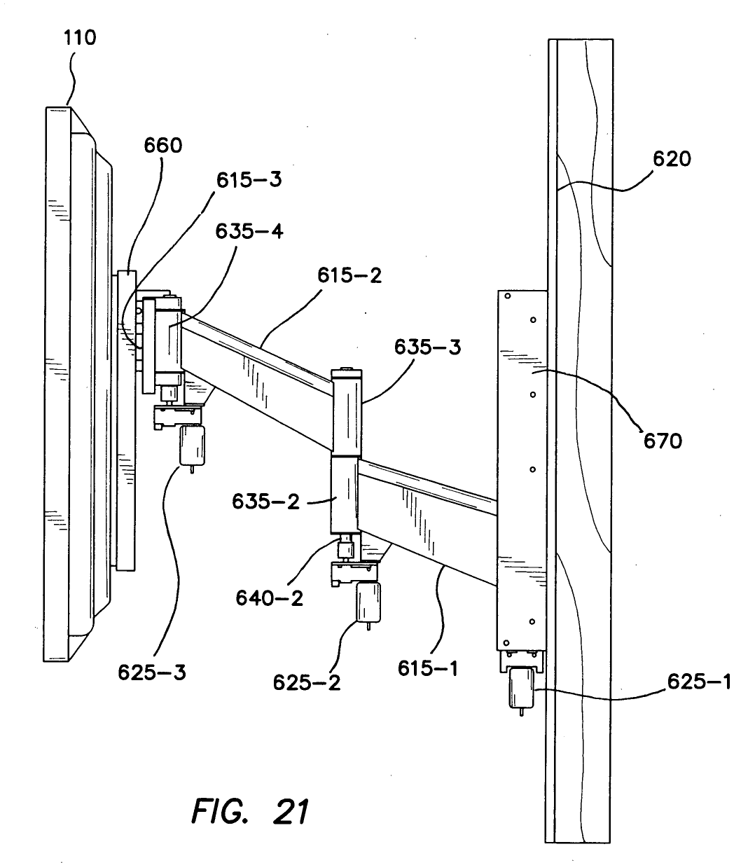

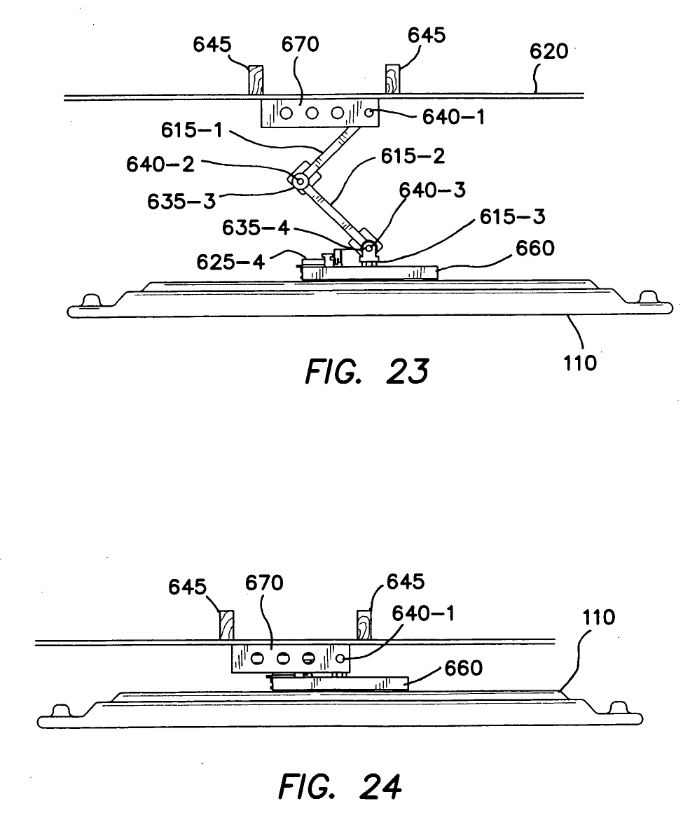

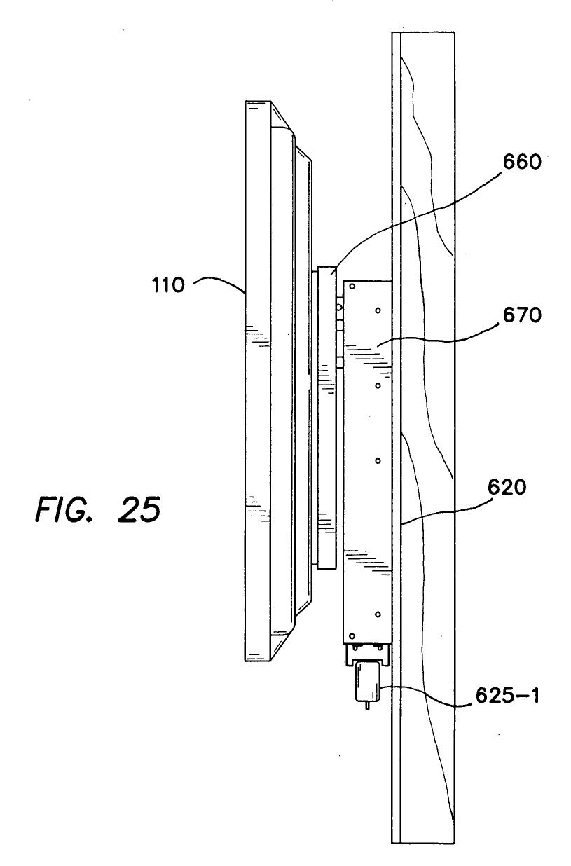

FIGS. 21-25 show a surface-mounted embodiment. More specifically, FIG. 21 shows a fully extended side view, FIG. 22 shows a fully extended top view, FIG. 23 shows a partially extended top view, FIG. 24 shows a top view of the FPT 110 in a home position and FIG. 25 shows a side view of the FPT 110 in a home position.

In the surface-mounted embodiment, a surface bracket 670 is attached to two parallel wall studs 645 but from on a surface of the wall 620 rather than between the wall studs 645. The primary difference between the recessed embodiment and the surface-mounted embodiment is the distance between the FPT 110 and the wall 620 in the home position. That is, the FPT 110 rests farther from the wall 620 in the wall mounted embodiment.

Although the invention has been described in detail with reference to several embodiments, additional variations and modifications exist within the scope and spirit of the invention as described and defined in the following claims.

We claim:

1. A flat panel television mounting system comprising:
a movable arm extending between a wall and a flat panel television;
at least one motor wherein the at least one motor controls movements of the arm and attached flat panel television; and
a signal receiver for receiving remote control signals for manipulating a position of the arm thereby re-positioning the flat panel television relative to the wall.

2. The flat panel television of claim 1 wherein the arm comprises a first and section independent section.

3. The flat panel television of claim 2 further comprising two motors wherein a first motor controls the first arm section and a second motor controls the second arm section.

4. The flat panel television mounting system of claim 1 further comprising a third arm section integrated between the second arm section and the flat panel television.

5. The flat panel television mounting system of claim 3 further comprising a third motor for controlling swivel movements of the flat panel television.

6. The flat panel television mounting system of claim 1 further comprising a fourth motor for controlling tilt movements of the flat panel television.

7. The flat panel television mounting system of claim 1 wherein the rigid structure is a wall.

8. The flat panel television mounting system of claim 7 further comprising a wall support mounted between wall studs.

9. The flat panel television mounting system of claim 6 further comprising a wall support mounted on a surface of the wall.

10. The flat panel television mounting system of claim 1 further comprising one or more sensors used to automatically stop movement of the flat panel television in response to the sensors identifying an object in a path of the flat panel television's movement.

11. The flat panel television mounting system of claim 1 further comprising means for tracking real time positional information of the flat panel television.

12. A flat panel television mounting system comprising:
an elongated member comprising a first movable arm section and a second movable arm section, said first and second arm sections extending between a rigid structure and the flat panel television;
at least two motors wherein a first motor controls movements of the first arm section and a second motor controls movements of the second arm section; and
a signal receiver for receiving control signals for manipulating a position of the first and second arm sections thereby positioning the flat panel television relative to said rigid structure.

13. The flat panel television mounting system of claim 12 further comprising a third arm section extending between the second arm section and the flat panel television.

14. The flat panel television mounting system of claim 13 further comprising a third motor for controlling the third arm section to swivel the flat panel television.

15. The flat panel television mounting system of claim 12 further comprising a motor for controlling a tilt function of the flat panel television.

16. The flat panel television mounting system of claim 12 wherein the rigid structure is a wall.

17. The flat panel television mounting system of claim 16 further comprising a wall support mounted between wall studs.

18. The flat panel television mounting system of claim 16 further comprising a wall support mounted on a surface of the wall.

19. The flat panel television mounting system of claim 16 further comprising one or more sensors.

20. The flat panel mounting system of claim 19 wherein sensor outputs are used to prevent the flat panel television from striking the rigid structure or other objects in a movement path of the flat panel television.

21. The flat panel mounting system of claim 12 further comprising a software element which tracks a real time position of the flat panel television.

22. A flat panel television mounting system comprising:
a first arm section, said first arm section connected at a first end to a first drive shaft, wherein said first drive shaft is mounted to a rigid structure, and connected at a second end to a second drive shaft;
a second arm section connected at a first end to the second drive shaft and connected at a second end to a third drive shaft;
a third arm section connected at a first end to the third drive shaft and connected at a second end to a flat panel television mounting bracket;
a series of motors for rotating said first, second and third drive shafts; and
a signal receiver for receiving control signals for manipulating a position of the first and second arm sections thereby moving the flat panel television relative to said rigid structure.

23. The flat panel television mounting system of claim 22 wherein the rigid surface is a wall.

24. The flat panel television mounting system of claim 23 further comprising three motors wherein each motor controls a corresponding drive shaft.

25. The flat panel television mounting system of claim 24 further comprising a fourth motor for controlling a tilt function of the flat panel television.
